(19) United States
(12) Patent Application Publication
(10) Pub. No.: US 2010/0071129 A1
(43) Pub. Date: Mar. 25, 2010

(54) BED, AND METHOD FOR TRANSFERRING CARE-NEEDING PERSON FROM THE BED

(76) Inventor: Osamu Yokota, Hamada-shi (JP)

Correspondence Address: EDWARDS ANGELL PALMER & DODGE LLP, P.O. BOX 55874, BOSTON, MA, 02205, US

(21) Appl. No.: 12/312,642

(22) PCT Filed: Nov. 19, 2007
(86) PCT No.: PCT/JP2007/072347

§ 371 Date: May 20, 2009

(30) Foreign Application Priority Data
Nov. 24, 2006 (JP) 2006-317415
Apr. 27, 2007 (JP) 2007-117880

(51) Int. Cl. A61G 7/10

(52) U.S. Cl. 5/83.1

(57) ABSTRACT

A bed having a purpose of transferring a care-requiring person lying in bed from the bed, the bed having a structure in which there are provided arranged a main bed and a position adjustment bed supported collectively movably up and down, and a suspending equipment below the main bed, and at a further lower position with an auxiliary bed which makes a swing movement, the main bed having a function of moving-away swing movement, the main bed and the position adjustment bed adjacent thereto each having a sheet with its one end fixed to the adjoining sides of the beds and the other end mounted to a sheet-fixing bar of a swing arm at the main bed side and the position adjustment bed side, the swing arms having a rotation axis near the adjoining parts of the beds.

### FIELD OF THE INVENTION

The present invention relates to an improvement of a bed to be used for nursing a person needing to be cared for or helped, such as bedridden patients, elderly people, physically disabled persons, etc.

### BACKGROUND OF THE INVENTION

Excretion is an action most frequent in everyday life. And keeping human bodies clean is essential for living a healthy life. The action is substantially a burden to the care-needing persons physically and mentally, and the physical burden to them largely affects the carers, too.

There have been proposed many nursing equipments having various structures for the purpose of assisting helping the persons requiring care, such as a bed incorporating equipments of necessities of life, for example, a toilet bowl, a bathtub, or the like, and a lift which transfers the care-requiring person to the life-necessities equipments. Also, as disclosed in the Patent Document 1, there has been developed a bed with which the care-requiring person when transferred bears a less burden. Patent Document 1: Unexamined Japanese patent application HEI 11-056926 (1999)

### DISCLOSURE OF THE INVENTION

### Problems That the Invention is to Solve

In case that excretion or taking a bath essential for everyday life is an object aimed for to be solved by the invention, the invention necessarily involves transferring of the care-requiring persons themselves where it is likely that it is quite hard for the care-requiring person to move onto a transferring means. To the contrary, a feature incorporating a transferring means at a nursing bed, etc does almost not require the care-requiring person to move, while inherent functions of beds are spoiled, leading to that comfortableness on the bed is lowered and the bed finally becomes not used.

Also, movement of rolling or turning over in bed for preventing a bedsore on their back, and rehabilitation exercise for preventing physical stiffening are indispensable for bedridden persons requiring care and also necessitate a heavy burden to carers. Moreover, as long as the care-requiring persons are nursed or helped by the carers, their privacy is neglected absolutely. Mitigation of mental pain from this is a task to be considered.

### Means for Solving the Problems

Under the above circumstances, the inventor long worked on and studied the foregoing problems and finally achieved the present invention characterized with such features: firstly, that a purpose is to cover the care-requiring person lying on the bed with a covering or upper “futon” bedding (Japanese quilted bedding placed ordinarily on the floor) and remove the covering futon bedding, and there is provided a structure consisting of futon-supporting pipes provided near the four corners of the covering futon bedding, a vertical movement slider for moving up and down the futon-supporting pipes, and thin wire inserted into the futon-supporting pipes, one end of the thin wire being connected to the covering futon bedding and the other end to a pulling and urging device; or

that there is provided a tubular member which covers the body of the care-requiring person so as to cause the care-requiring person to put on the tubular member, the tubular member being provided along its longitudinal direction with a slide fastener having a slider, the slider being to be moved for at least partially opening and spreading the tubular member to thereby enable the tubular member to be put on and taken off, the slider of the slide fastener being provided with an endless wire member for opening and closing the tubular member, and a guide which supports the wire member movably along a side of the slide fastener; or

that there is provided a bed having a purpose of transferring a care-requiring person lying in bed from the bed, the bed having a structure in which there are provided arranged a main bed and a position adjustment bed supported collectively movably up and down, and a suspending equipment below the main bed, and at a further lower position with an auxiliary bed which makes a swing movement, the main bed having a function of moving away swing movement, the main bed and the position adjustment bed adjacent thereto each having a sheet with its one end fixed to the adjoining sides of the beds and the other end mounted to a sheet-fixing bar of a swing arm at the main bed side and the position adjustment bed side, the swing arms having a rotation axis near the adjoining parts of the beds; or

that there is provided a method of transferring a care-requiring person lying in bed wherein swing arms of a main bed and a position adjustment bed adjacent thereto (the beds each having a sheet with its one end fixed to the adjoining sides of the beds and the other end mounted to a fixed bar of the respective swing arm at the main bed side and the position adjustment bed side, the swing arms having a rotation axis near the adjoining parts of the beds) are operated to transfer a person requiring care from the main bed to the position adjustment bed, and the care-requiring person is further transferred from the position adjustment bed to an auxiliary bed (on whose surface a suspending equipment is positioned) by a moving-away swing movement of the main bed, moving-up and swing movement of the auxiliary bed (which is provided below the suspending equipment below the main bed to make swing movement) and operation of the swing arm at the position adjustment bed side, so that the care-requiring person is transferred into such state as being suspended with the suspending equipment by the collective moving-up movement of the main bed and the position adjustment bed, and the suspending equipment's suspending belt's moving-up following the beds moving-up movement.

A vertical movement slider referred to herein is a device for moving up and down the futon-supporting pipes by use of a belt drive by a motor, an air cylinder, or the like. A thin wire is inserted into the futon-supporting pipes and is connected at its one end to four corners of the covering futon bedding and at the other end to a pulling and urging device. The pulling and urging device urges the thin wire connected to the covering futon bedding in the direction of pulling the thin wire and may employ a winding drum using a weight, a spiral spring, etc. The pulling and urging device allows the covering futon bedding to be put on the care-requiring person with freedom to some extent. For taking off the covering futon bedding, the vertical movement slider is moved up in the state that the care-requiring person is covered with the covering futon bedding. In this case, at or before the limit of pulling the wire by the spiral spring, only the futon-supporting pipe rises without the covering futon bedding's movement. The futon-supporting pipe is further raised to cause the covering futon bedding to be lifted and removed from the care-requiring person. This operation of the covering futon bedding by the vertical movement slider may be employed not only for putting on and taking off the covering futon bedding but also for correcting placement of the covering futon bedding when not in a predetermined position.

The “tubular member” is a part of a nursing nightclothes which is to be put on by the care-requiring person in a manner of covering their body, arms, and legs and corresponds to the body part and sleeves of a jacket, and trousers, a skirt or the like. The jacket and trousers and skirt may be formed integrally or separately. A slide fastener is provided longitudinally of the tubular member part, so that the tubular member is structured to be opened and spread to allow the care-requiring person to put on and take off the tubular member. In this case, the slide fastener when completely opened needs rather hard operation for closing the slide fastener. The slide fastener is preferably structured to be able to be opened and spread with the slide fastener being partially kept closed.

The “wire member” is an endless member fit to the slider of the slide fastener to allow the slider to move going to and back. The wire member is supported movably through the “guide” provided along a side of the slide fastener, so that the wire member is operated to be merely drawn in at an almost constant position without much shifting operator's hand to allow the slider to be moved over the whole region of the slide fastener.

The “guide” is provided to extend at a side of the slide fastener in the substantially same length, so that it enables the slider's opening and closing movement with the wire member. For example, when the slide fastener is to be opened, the wire member may be pull out as sending out consequently from the guide so that the slider is pulled in the direction of opening the slide fastener. And, when the slide fastener is to be closed, the slider may be directly pulled with the wire member. Hence, the slider is able to make opening and closing operation over the whole region of the slide fastener without necessity of shifting operator's hand. Shapes and forms for the guide may be in a shape or form of pipe or hook so that the wire member is guided without being much exposed to outside.

A “plane” fastener (a hook-and-loop fastener) maybe formed on the nursing nightclothes, so that the nursing nightclothes after taken off is held on the bed. Minutely, since some of the beds for nursing are structured to get up or turn over, the nightclothes when held at the same position by the plane fastener is easy to be put on by the care-requiring person who returns to the bed after taking off the nightclothes and moving away for excretion or taking a bath, etc. A position on the nightclothes for providing the plane fastener is not particularly limited but may be a point where the slide fastener is opened and the nightclothes is spread, whereby the nightclothes is easily put on by the care-requiring person, and the plane fastener at that point does not hinder the care-requiring person from putting on the nightclothes.

The “main bed” is a bed mainly used by the care-requiring person. The bed according to the present invention is so structured that the main bed and the position adjustment bed are provided together. The main bed and the position adjustment bed each has thereon a sheet with its one end fixed to the adjoining sides of the beds and the other end mounted to a swing arm at the main bed side and the position adjustment bed side respectively. The respective swing arms at the main bed side and the position adjustment bed side have a rotation axis near the adjoining parts of the beds and rotate around the rotation axis. Rotating movement of the swing arms peels the sheet from the beds and the care-requiring person lying on one of the beds is transferred to the other. Besides, the sheet fixing bars of the swing arms to which the foregoing other ends of the sheets are mounted may be kept in a state of being raised to some extent, allowing the fixing bar to serve as a frame preventing falling from the beds.

The sheets may employ a mounting means such as a fastener, a button, a snap, etc to thereby be easily replaceable. In this case, it is preferable to make use of a fastener with a key, so that a person requiring care having a disease such as dementia is prevented from peeling the sheets.

The “suspending equipment” is a device for transferring the care-requiring person from the bed into a suspended state, and supporting the person. Suspending the care-requiring person with the suspending equipment enables the person to be transferred to equipments of necessities of life, such as a toilet bowl, a bathtub, a wheel chair, a dining table and chair. The suspending equipments may be a net, cloth, a plastic sheet, or the like, and carry the care-requiring person on the equipment in the state of suspending the person to transfer the person from the bed to an aimed equipment (such as a toilet bowl). Operation for causing the care-requiring person to go into the suspending equipment from the bed without a burden to the person is made with a combination of the foregoing turning-over movement by the main bed and the position adjustment bed, and the separately provided auxiliary bed formed below the suspending equipment. The suspending equipment may be moved up and down by means of a motor, etc, and may otherwise be connected to a winding drum urged by a spiral spring so that the suspending equipment is moved up and down through operation of vertical movement of the main bed and auxiliary bed. Furthermore, the necessities of life equipments may be installed on the floor or may otherwise be mounted to a frame to which the auxiliary bed is supported in a manner of being capable of sliding and moving up and down. In this case, a folding structure maybe used to enable storage to be made compactly.

The “body position detection mechanism” is provided in the bed to grasp existence and non-existence of a person requiring care in bed, specific positions of the person on the bed, etc. Such information may be employed for the purpose of watching wandering, or adjusting the person's positions with respect to the suspending equipment, etc. The body position detection mechanism may be various kinds of sensors such as a limit switch, pressure sensor, etc, which is provided under or in a cushion of beds to detect weight, body temperatures of the care-requiring person in order to obtain information of positions.

The “switch box” is provided for operation of beds or the like by the care-requiring persons themselves when they move by themselves. For enabling the care-requiring person to operate the switch while moving, a wireless switch using infrared or the like is employed usually. A cabled switch may be employed when structured provided with a brake mechanism which does not slacken cable and prevents unexpected drawing the cable, so that the cabled switch can be held at a position within reach of the care-requiring person.

### Effects of the Invention

A method of transferring a person requiring care from a bed according to the present invention does automatically perform the transferring to various equipments of necessities of life such as a toilet bowl, a bathtub, etc having different purposes. Hence, the method mitigates many problems of families having bedridden patients and of patients themselves, improves many points related to problems created at the site of care and notable social problems, and thereby shows practically extremely useful effects.

### BRIEF DESCRIPTION OF THE DRAWINGS

FIG. 1 is a side view showing an example of a device for covering with and removing a covering futon bedding for nursing according to the present invention (Example 1).

FIG. 2 is a side view showing another example of a device for covering with and removing a covering futon bedding for nursing according to the present invention.

FIG. 3 is a plan view showing the state of arrangement of the main bed and the position adjustment bed (Example 2).

FIG. 4 is a side view showing the state in which the covering futon bedding is removed.

FIG. 5 is a side view showing the state that the care-requiring person is about to be transferred to the auxiliary bed after turning over to the position adjustment bed.

FIG. 6 is a side view showing the state that the care-requiring person is transferred by a suspending net to be supported on the auxiliary bed.

FIG. 7 is a perspective view showing the state illustrated in FIG. 6.

FIG. 8 is a side view showing the state that the care-requiring person is suspended by the suspending net while the auxiliary bed is moved away and put aside to a predetermined position.

FIG. 9 is a perspective view showing a controller for a suspending belt (Example 3).

FIG. 10 is a perspective view showing a swing movement mechanism for the main bed and the position adjustment bed (Example 4).

FIG. 11 is a side view showing a swing movement mechanism for the auxiliary bed (Example 5).

FIG. 12 is a schematic view showing a cable controller of the switch box (Example 6).

FIG. 13 is a perspective view showing arrangement of peripheral equipments with respect to the beds and a bed-slanting mechanism (Example 7).

FIG. 14 is a perspective view showing an example of the body position detection mechanism (Example 8).

FIG. 15 is a plan view showing an example of a nursing nightclothes according to the present invention, FIGS. 15(a) and 15(b) illustrating a nightclothes used in bed for both uses of toilet and taking a bath (Example 9).

FIG. 16 is a partially illustrated front view showing the state of the slide fastener being opened and closed.

FIG. 17 shows another example of the nursing nightclothes according to the present invention. FIG. 17(a) is a front view and 17(b) a rear view (Example 10).

FIG. 18 is a perspective view showing the state that the care-requiring person is caused to turn over to the position adjustment bed (Example 11)

FIG. 19 is a perspective view showing the state that the care-requiring person has been completely transferred to the position adjustment bed after the turning over movement.

FIG. 20 is a perspective view showing the state that the main bed is moved away and put aside after the care-requiring person has been turned over and moved to the position adjustment bed.

FIG. 21 is a perspective view showing the state that the care-requiring person who has been turned over and moved to the position adjustment bed is moved down to the level of the auxiliary bed.

FIG. 22 is a perspective view showing the state that the care-requiring person is transferred from the position adjustment bed to the auxiliary bed.

FIG. 23 is a perspective view showing the state immediately after the care-requiring person has been transferred to the auxiliary bed.

FIG. 24 is a perspective view showing the state that with the care-requiring person having been transferred to the auxiliary bed, the swing arm at the position adjustment bed side is returned.

FIG. 25 is a perspective view illustrating the whole of the toilet bowl device, with a side view showing a positional correlation between the toilet bowl device and the bed.

FIG. 26 is a perspective view showing the state that the main bed and the position adjustment bed are moved up to suspend the care-requiring person.

FIG. 27 is a perspective view showing the state that the auxiliary bed is moved down so that the care-requiring person is completely suspended.

FIG. 28 is a perspective view showing the state that the auxiliary bed is moved away and put aside laterally and the suspended care-requiring person is positioned above the toilet bowl device.

FIG. 29 is a perspective view showing the state that the toilet bowl device is assembled into a relaxing chair serving also as a toilet.

FIG. 30 is a plan view showing arrangement of the tower-shaped tank and others at the bed structure.

FIG. 31 is a perspective view showing the state that the suspended care-requiring person has been placed on the relaxing chair serving also as a toilet.

FIG. 32 is a perspective view showing the state of use of the relaxing chair serving also as a toilet being raised up.

FIG. 33 is a perspective view showing the state that the auxiliary bed is set upright when using a bathtub (Example 12).

FIG. 34 is a perspective view showing the state that the auxiliary bed is moved up when using the bathtub.

FIG. 35 is a perspective view showing the state that the auxiliary bed is moved up and the toilet bowl device is moved away and put aside laterally when using the bathtub.

FIG. 36 is a perspective view showing the state that the bathtub is moved and set up.

FIG. 37 is a perspective view showing the state that the suspended care-requiring person is placed down in the built bathtub.

FIG. 38 is a perspective view showing the state that the care-requiring person uses the bathtub.

FIG. 39 is a cross-sectional view showing an example of the bathtub.

FIG. 40 is a front view showing arrangement of the toilet bowl device and the bathtub in the bed.

FIG. 41 is a front view showing the state that the whole of the main bed and the auxiliary bed are moved up as a preliminary movement for setting up the bathtub.

FIG. 42 is a front view showing the state that the whole of the main bed and the auxiliary bed are moved up, and the toilet bowl device is moved away and put aside laterally.

FIG. 43 is a front view showing the state that the bathtub is moved and set up.

FIG. 44 is a front view showing the state that the set up bathtub is arranged in parallel to the toilet bowl device.

FIG. 45 is a perspective view showing positional correlation between the toilet bowl device and the bathtub.

FIG. 46 is a schematic view showing another example of the switch box (Example 13).

FIG. 47 is a perspective view showing a further example of the bed according to the present invention (Example 14).

FIG. 48 is a perspective view showing a further example of the bed according to the present invention.

### DESCRIPTION OF REFERENCE NUMERALS

1 Bed according to the present invention
2 Device for covering with and removing a covering futon bedding for nursing
3 Main bed
4 Sheet-fixing bar at the main bed side
5 Swing arm at the main bed side
6 Position adjustment bed
7 Sheet-fixing bar at the position adjustment bed side
8 Swing arm at the position adjustment bed side
9 Suspending net
10 Suspending belt
11 Auxiliary bed
19 Sheet at the main bed side
20 Sheet at the position adjustment bed side
24 Belt controller
76 Nightclothes for lower part of body
77 Nightclothes
112 Set up-type bathtub
113 Toilet bowl device

### MOST PREFERABLE EMBODIMENTS OF THE INVENTION

The main bed, the body position adjustment bed arranged laterally of the main bed, and the auxiliary bed provided below and separately from the body position adjustment bed provides that the care-requiring person is turned over and moved repeatedly to be transferred onto the suspending net and automatically to the equipments of necessities of life prepared below the net. Also, operation of the suspending belt of the suspending net enables support for rehabilitation exercise on the suspending net.

### EXAMPLE 1

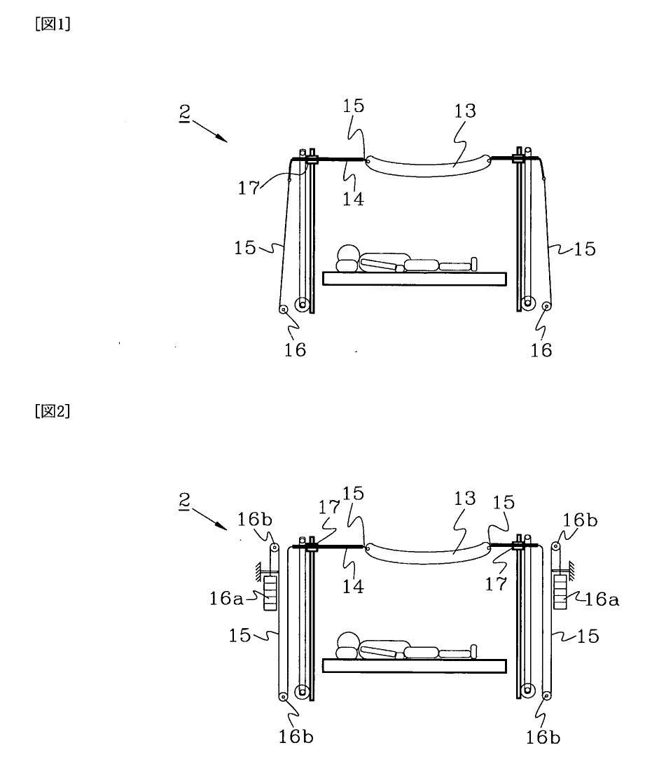

FIG. 1 shows an example of a device 2 for covering with and removing a covering futon bedding for nursing according to the present invention. The figure is an explanatory view for that in nursing a person requiring care such as a bedridden patient, work (to be initially performed) of moving the covering futon bedding 13 and moving back the same is automatically performed. The covering futon bedding 13 which the care-requiring person puts on mounts wire 15 at the four corners. The wire 15 is inserted into a supporting pipe 14 and is connected at the other end to a wire controller 16 (the pulling and urging device). The supporting pipe 14 is fit to a vertical movement slider 17. First, when the vertical movement slider 17 is moved up, only the vertical movement slider 17 goes up but the covering futon bedding 13 does not move. This is because the wire controller 16 consists of a winding drum urged with a spiral spring, so that the covering futon bedding 13 keeps as it is until the wire 15 is drawn out to the limit against the spiral spring while only the supporting pipe 14 fixed to the vertical movement slider 17 moves. In this state the supporting pipe 14 is further moved up, the covering futon bedding 13 is lifted by the wire 15 to a highest position as shown. When the slider 17 is moved down, the futon bedding 13 also moves down and to a predetermined position upon completion of moving down. This enables that the covering futon bedding 13 if shifted upon the care-requiring person's sleeping can be adjusted, whereby the futon bedding 13 can be put on at a correct position by the care-requiring person.

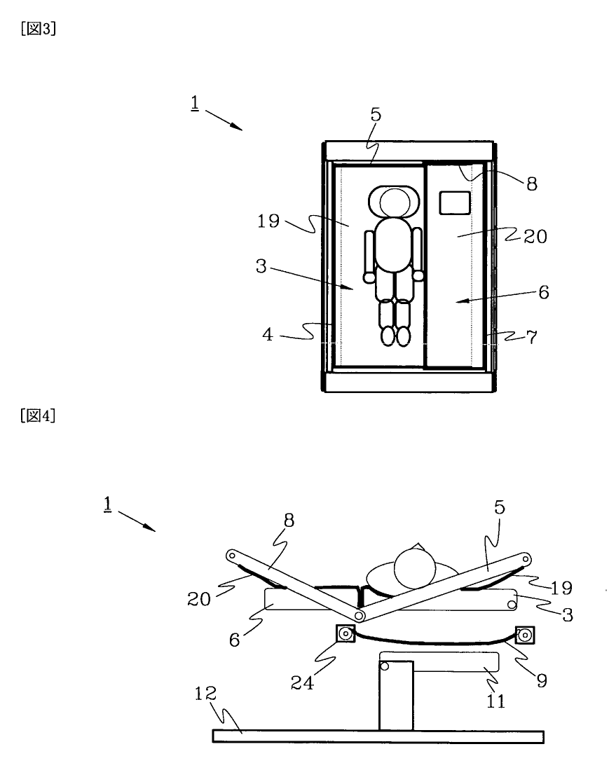

The pulling and urging device may comprise a weight 16a and a pulley 16b as shown in FIG. 2. In this example, a holding means 17a for holding the covering futon bedding 13 at its moved-up position is provided. The holding means 17a has the same structure as of the wire controller 16 and connects a spring of constant load to the vertical movement slider 17. By this, the vertical movement slider 17 is not to be kept at its moved-up position by use of a motor or the like, thereby being effective in the aspect of saving power and for a situation of power failure.

### EXAMPLE 2

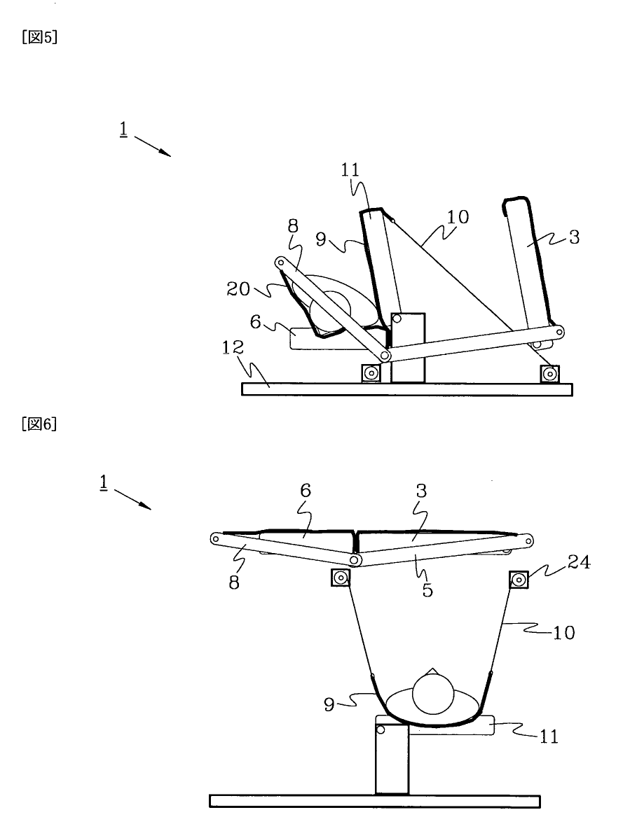

FIG. 3 is a plan view showing an example of a bed 1 according to the present invention, i.e., a main bed 3 and a position adjustment bed 6, wherein the covering futon bedding 13 is moved away and put aside from the care-requiring person lying in bed by use of the forgoing device 2 for nursing, and covering with and removing a covering futon bedding, and a nightclothes 77 for use only in bed described later is operated to bring the person on the bed into a stark-naked state. The main bed 3 and the position adjustment bed 6 are provided with a swing arm 5 at the main bed side and a swing arm 8 at the adjustment bed side as shown in FIG. 4. The swing arms when brought into a state of being slightly lifted up have the same purpose as of a pipe frame on ordinary beds for preventing falling from the beds. For allowing direct getting down to the floor from the main bed 3, the swing arm 5 at the main bed side may be moved down to the level of the bed, providing the same situation as the pipe frame for preventing falling being removed. For automatically transferring the care-requiring person from the main bed 3, the person is first caused to turn over to thereby be first brought into a state of lying prone on the position adjustment bed 6. For this operation, the swing arm 5 at the main bed side provided with a sheet fixing bar 4 at the main bed side is moved up. If only the swing arm 5 is moved up, the person's body will sharply roll on the position adjustment bed 6. Thus, the swing arm 8 at the position adjustment bed side is previously almost perpendicularly raised up. And both swing arms 5 and 8 interlock with each other, so that a smooth turning over movement is enabled with a sheet 19 at the main bed side and a sheet 20 at the adjustment bed side. Pillows formed on the sheets 19 and 20 may be preferably fixed by use of the plane fastener or the like for preventing falling. In this case, turning over movement is possibly hindered by the pillows. Hence, the sheet 19 at the main bed side and the sheet 20 at the position adjustment bed side may be preferably provided with a swollen part or a pocket into which the pillows are accommodated. By this, the pillows work as an ordinary pillow when the sheets are placed on the beds, and the pillows sink when the sheets move away from the beds.

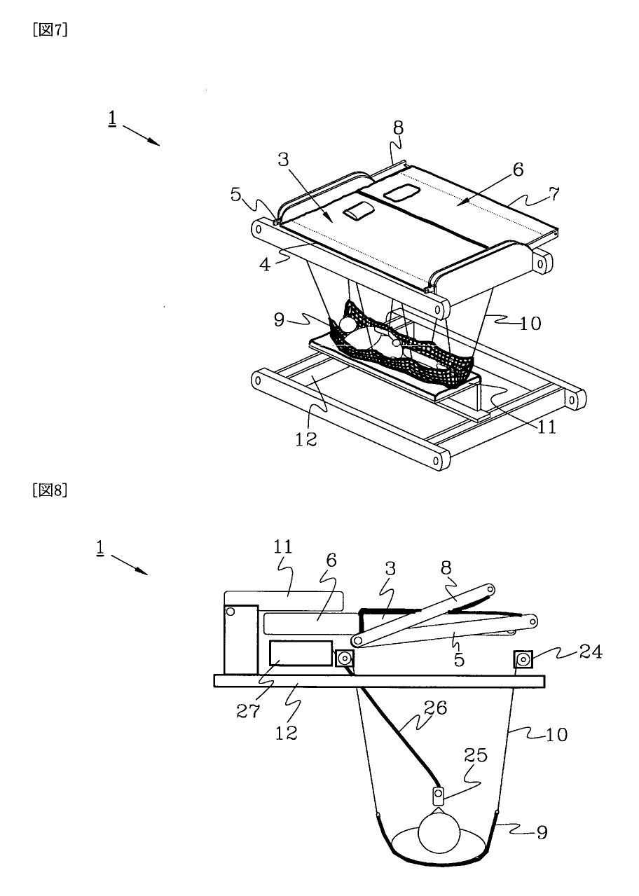

FIG. 5 is an explanatory view for the care-requiring person's turning over movement from the position adjustment bed 6 to an auxiliary bed 11. While or after the main bed 3 is caused to move away and swing as shown, the main bed 3 and the position adjustment bed 6 are moved down. In this case, the auxiliary bed 11 may be moved up, so that the auxiliary bed 11 with a suspending net 9 (the suspending equipment) put thereon is arranged with the position adjustment bed 6 side by side. In this state, the auxiliary bed 11 makes swing movement to a state for receiving the person's body, and, then, interlocks with the swing arm 8 at the position adjustment bed side to cause the care-requiring person to turn over onto the auxiliary bed 11 with the net 9 being sandwiched between the person and the bed. The position adjustment bed 6 interlocking with the main bed 3 is then moved up to the upper end. If the beds as they have been are moved up, the main bed 3 which has made swing movement would contact with a bed upper face cover heat insulation sheet. Thus, as shown in FIG. 6, the swing arm and beds are shifted almost horizontally at a predetermined height level. In this instance, the suspending belt 10 is free and has only a faint winding force with the spiral spring. When the beds 3 and 6 are moved up, the belt 10 is drawn out, and, the care-requiring person is held in the state of being suspended with the suspending net 9 below the beds 3, 6 as seen in FIG. 7.

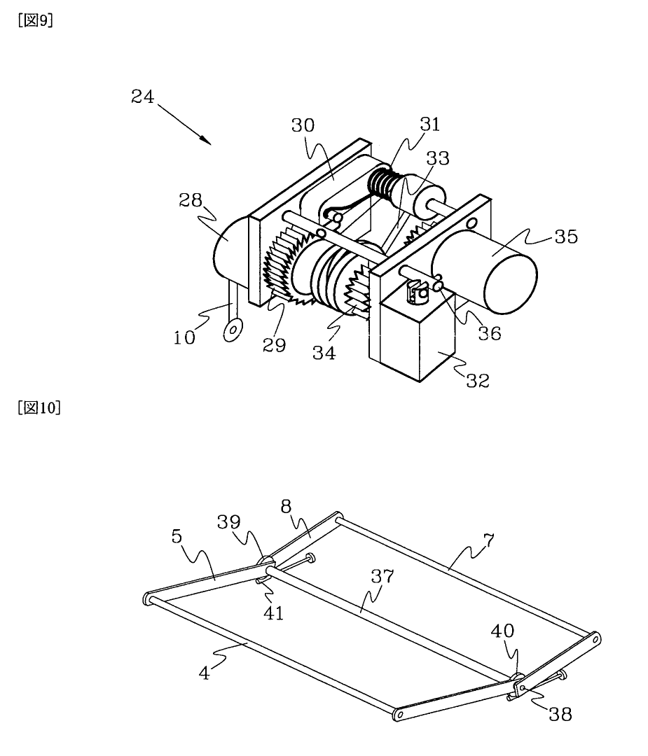

FIG. 8 shows the state that the body of the person is supported only by the suspending net 9 and that the auxiliary bed 11 is accommodated in a manner of being piled up over the main bed 3. After the main bed 3 and the position adjustment bed 6 as a whole are moved to the upper end, a belt controller 24 is operated to set a locking state to prevent the belt 10 from being drawn, and the auxiliary bed 11 is moved down. When the body suspended by the net 9 becomes into a state of not contacting with the auxiliary bed 11, the auxiliary bed 11 is moved to a lateral end by a slide mechanism unit 12. And the auxiliary bed 11 is swung to be perpendicular and moved up. Then, the main bed 3 and the position adjustment bed 6 as a whole are moved down to a point near the auxiliary bed slide mechanism 12. To avoid collision between the auxiliary bed 11 and the swing arm 8 at the adjustment bed side, the swing arm 8 is caused to swing toward the main bed 3 while being moved down.

By this, the auxiliary bed 11 is caused to make swing movement over the position adjustment bed 6, so that the beds as a whole are compactly piled up as shown. In this state, the whole of the main bed 3 and position adjustment bed 6, and the auxiliary bed 11 are interlocked and be moved down, so that the care-requiring person is automatically transferred to an aimed equipment (toilet bowl, bathtub, etc). Thereafter, the belt controller 24 is set to be free and the whole of the beds are moved up to the upper end, whereby a large space is formed between the care-requiring person and the beds placed above the person, so that nursing work is readily performed by carers, etc.

As countermeasures for mitigating problems in bedridden persons requiring care, namely, interruption in blood circulation such as bedsore, and progress of dementia, it is necessary to live in the state of the body being raised to a possible extent in the daytime. In this respect, the bed 1 according to the present invention improves those problems by use of the slanting function as a whole of the bed, and the transferring to the wheel chair, relaxing chair, etc prepared below the bed.

### EXAMPLE 3

FIG. 9 is a perspective view showing details of the belt controller 24 referred to in the above explanation. A belt controller usually employs a motor. A spiral spring 33 is used for winding the belt in respect of cost and making smaller the device. And drawing out the belt depends upon weight of the person requiring care. Upon drawing out the belt, in case that the care-requiring person is on the net 9, when solenoid 32 is applied with positive electric current in a short time, (due to magnet latch operation type in which a drive lever 36 holds a ratchet pawl 30 in being disengaged), the belt 10 is applied with only a weak winding force by the spiral spring 33. In this situation, when the main bed 3 side or the auxiliary bed 11 side are moved up or down, the belt 10 is wound into or drawn out of an accommodation case 28 following the movement of the beds 3, or 11 sides. The movement of the beds sides and information of positions are collected by a potentiometer 35.

At an aimed belt position, when electric current opposite to the above is fed to the solenoid 32, the latchet pawl 30 is released from the state of being disengaged to be set onto a ratchet gear 29 by an urging spring 31, thereby bringing the belt 10 into a locked state that the belt 10 cannot be drawn out. In this situation, the main bed side is moved up, or the auxiliary bed side is moved down, thereby providing the state of suspending the person's body using the suspending equipment. Reversely, the main bed 3 side is moved down, or, the auxiliary bed 11 side is moved up, the belt 10 is not wound but can be kept slackened since a force of the pawl urging spring 31 is higher than the winding force. This operation is to be performed when avoiding such a feel of unexpected pressure is desired that the belt winding force is applied to the body through the suspending equipment upon completion of transferring to aimed equipment, or when the suspending equipment and the belt 10 are to be separated when going out by the wheel chair.

Four belt controllers 24 for suspending operation are mounted at left-hand and right-hand sides, respectively, on the rear side of the main bed 3, (In total, eight belt controllers 24 for suspending are provided) so that the body of the care-requiring person is transferred with the suspending net 9. By use of this function, association of the vertical movement of the auxiliary bed 11 and eight belt controllers 24 enables performance of many rehabilitation exercises such as sit-up exercises, and bending and stretching exercises for leg/foot joints, or the like without carers.

### EXAMPLE 4

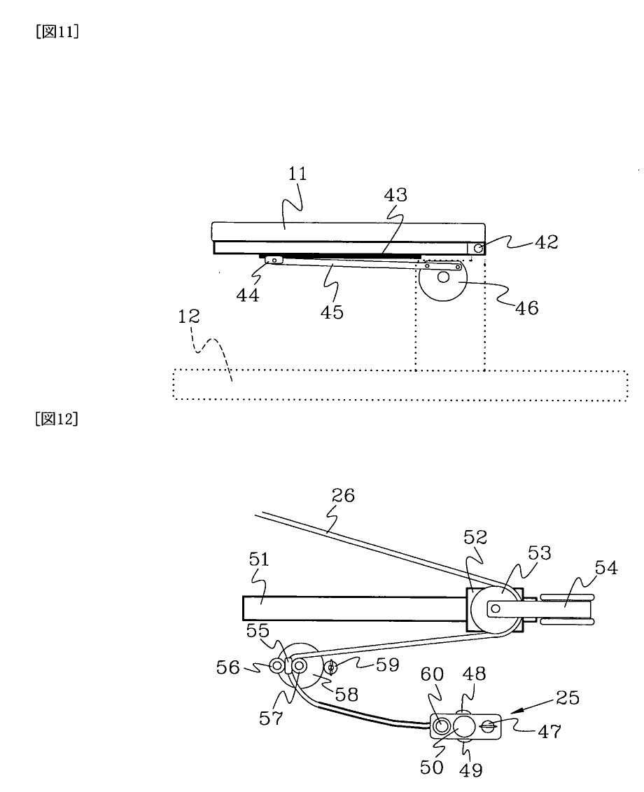

FIG. 10 shows a swing movement mechanism for a turning over movement between the main bed 3 and the position adjustment bed 6. The swing arm 5 at the main bed side is fit to a drive pipe axis 37 and the swing arm 8 at the position adjustment bed side to an axis 38 inserted into the pipe axis 37. The arms may be reversely fit. By the feature, the arms 5 and 8 have the same fulcrum of movement, so that upon cooperative movement of the arms, the care-requiring person is able to turn over and be transferred stably with reduced burden. Also, the axes 38 and 39 mount a worm wheel gear 40, 41 at both ends directly, thereby enabling simplification of a drive system and stabilization upon stoppage of movement.

### EXAMPLE 5

FIG. 11 shows a swing drive system for causing the auxiliary bed 11 to interlock with movement of the sheet created by the swing arm 8 at the position adjustment bed side. A movement fulcrum 42 at the auxiliary bed side is set at the end of the bed, so that the fulcrum 42 is near the movement fulcrum of the drive axis 38 at the side of the position adjustment bed 6 to a possible extent. And a bed lifting mechanism is arranged at the back side of the auxiliary bed 11 as shown. A slider 44 (a slide mechanism) mounted to the back of the auxiliary bed 11 is connected to an end of a swing arm 45 fixed to a worm wheel gear 46. Hence, the slider 44 is moved corresponding to rotational movement of the arm 45. The auxiliary bed 11 is enabled to make rising movement around the fulcrum 42, thereby enabling a stable turn-over cooperative movement with the position adjustment bed 6 side.

### EXAMPLE 6

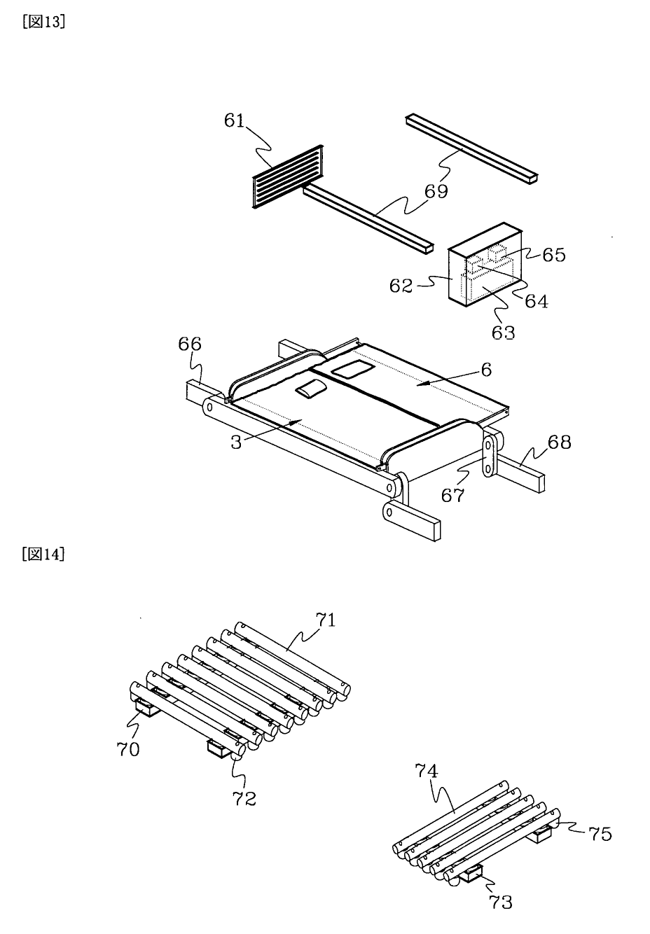

With a switch box 25 at hand to be controlled by the care-requiring person by oneself and a cable controller 27 provided under the position adjustment bed 6 shown in FIG. 12, the care-requiring person is enabled to be transferred to aimed equipment without letting go of the switch box 25. First, aimed equipment is selected with a change-over switch 47, and a “go” switch 48 is switched on by grasping the switch. A cable brake mechanism 59 is made free, and a weak winding force of a constant load spring 54 is applied to the cable while movement of transferring the body starts. Transferring of the care-requiring person grasping the box 25 causes the cable 26 to be drawn out. A slider 52 moves on the rail 51 leftwards, so that the cable 26 is drawn two times of the slider's movement distance.

A pressing roller 56 presses the cable 26 against a synchronizing roller 57 so as to rotate the roller 57 in synchronization with movement of the cable 26 in order to prevent the box 25 from shifting to any where away from the person's reach when the care-requiring person after transferred to the aimed equipment wants to let go of the switch box 25, or even in case the person in being transferred mistakably lets go of the switch box. The rotation is transmitted through a gear 58 to the cable brake mechanism 59 having a wing to rotate the mechanism 59 at a high speed, so that at an instance that the person's hand lets go of the go switch 48 or return switch 49 on the box 25, the brake mechanism 59 operates to prevent the cable from being drawn in. In this case, the brake mechanism 59 is provided with a high speed rotation wing for covering time lag with respect to start of operation. In other words, the mechanism is provided for making slow the speed of the cable 26 being drawn in to make minimum the quantity of moving of the cable 26.

### EXAMPLE 7

FIG. 13 shows arrangement of peripheral equipment in relation to the beds, and a slanting mechanism unit of the whole of beds 3 and 6. Exclusively-usable air conditioner 61 and lighting 69 having function of automatically adjusting brightness are provided for improving environment, energy saving and providing automatic operation in the beds covered with a draft-shutting type accordion curtain made of a heat insulation sheet or the like. The bed is provided above the side of feet with a casing 62 for vertical and slanting optimum automatic movement in which there are provided a television and monitor 63, an image transmission device 64 with camera, and a high-directional microphone 65, so that entertainment and conversation with a videophone are enjoyed and enabled. In this case, a comfortable posture can be taken by slanting the whole of the bed by means of a linkage mechanism 67 and so on for slanting. Further, also upon transferring to the relaxing chair or wheel chair, etc, the care-requiring person is transferred automatically to an optimum position and angle.

A patient who is not able to operate the switch due to any disorders will ask carers' operation. A carer even if not present there can make operation from a distant place by watching a scene of the patient by means of a camera 64 and a microphone 65 provided at feet side surface together with a television 63 which is changed of its vertical positions and slant automatically to an optimum state. This feature can deal with a problem of a person who is not enabled to work for a company since whose family has a bedridden person requiring care.

In addition to the forgoing purpose of the linkage mechanism 67, the linkage mechanism 67 does, together with the joint mechanism 66, 68, simplify synchronization conditions regarding interlocking between head side and foot side driving system in vertical movement of the bed. The same mechanism is adopted for the auxiliary bed 11 for the same purpose.

### EXAMPLE 8

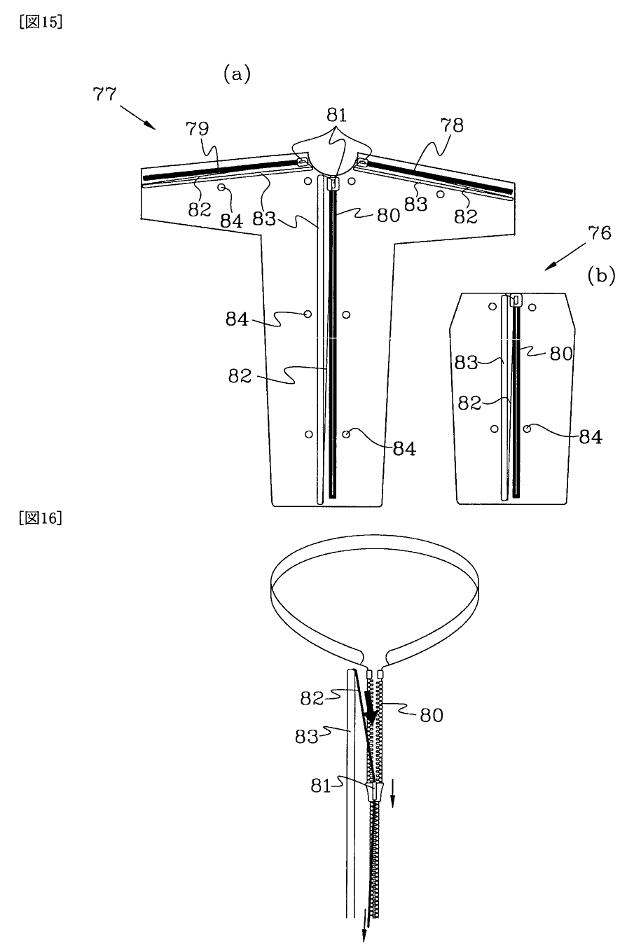

FIG. 14 shows an example of a body position detection mechanism to be put under cushion of the main bed 3 and auxiliary bed 11. By detecting positions of hip and foot, schematic positions of the body are recognized. Its purpose is to obtain information about body positions required in setting the suspending net 9 precisely to the body positions, or, correcting shifted body positions on the main bed 3, or the like. Also, the information may be usable as a urgent notice information, for example, when a patient of dementia moves away from the bed. A drive bar 70 for hip together with a support mechanism 71 and limit switches 72 at both ends is provided in several sets longitudinally of the hip part of the body. Besides, for foot part of the body, detection mechanisms having similar combination of a drive bar 73, support mechanism 74 and limit switches 75 are installed transversely. When the drive bar 70, 73 is applied at its any part with weight of the person from the above, either of the limit switches 72, 75 works, thereby enabling to obtain positional information regarding the body over upper half side, lower half side, left-hand side and right-hand side on the bed plane. Since positions where the switch is turned on are different according to size of the body of the care-requiring person, information to be obtained from relevant body positions is to be stored immediately before using the bed 1.

For example, in the state shown in FIG. 3, in case that the body of the care-requiring person shifts several centimeters toward the upper end on the plane of bed 3, first, the position adjustment bed 6 is previously caused to shift several centimeters toward the upper end of the bed plane from a predetermined position. Then, with the movement as explained with referring to in FIG. 5, the person is transferred to the position adjustment bed 6 which bed is then returned to a predetermined position. The person is transferred again to the main bed 3, thereby enabling correction of body position on the main bed 3 to a correct position. Even in case of largely shifting of the body position, the above steps when repeated several times enable correction of body positions.

### EXAMPLE 9

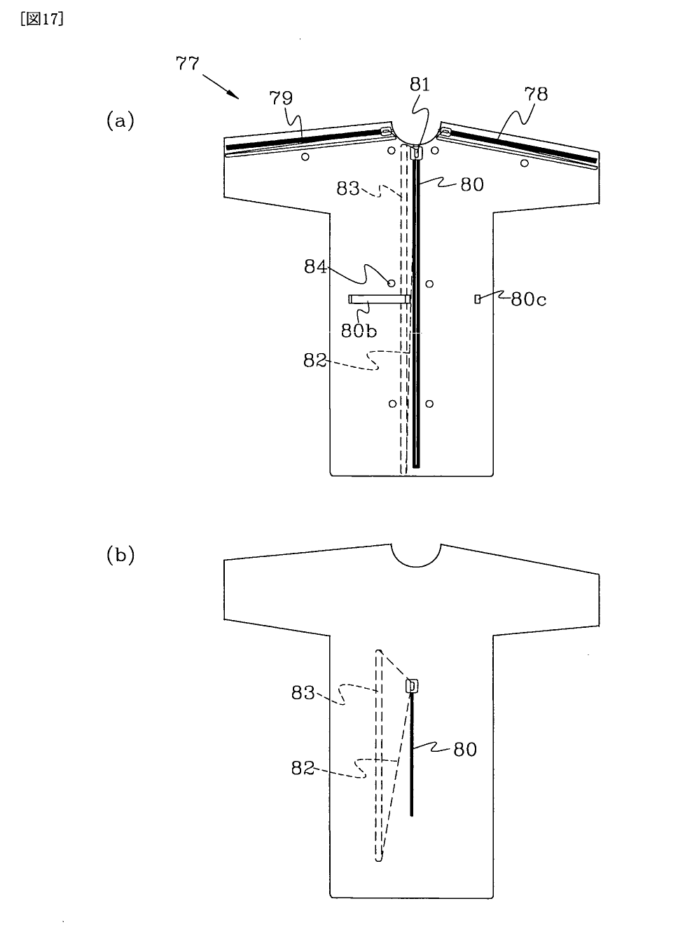

FIG. 15 shows a nursing nightclothes 77 (FIG. 15(a)) and that 76 for the lower half of the body (FIG. 15(b)) exclusively used for the bed, the nightclothes being capable of being opened to the parts of wrist and ankle. For the parts to be opened, thin wire 82 to operate fasteners and sliders is connected through a guide 83 to the fasteners 78, 79, 80 and sliders 81 for them. The person requiring care can move the slider 81 only by operating the wire 82 as shown in FIG. 16. The slider 81 is moved to the parts corresponding to wrist and ankle and the nightclothes 77 are opened. Hands and feet are pulled out of the nightclothes, thereby allowing the care-requiring person to take off the nightclothes 77. Then, the person is to be transferred to aimed equipment. A plane fastener 84 mounted to several points on the nightclothes 77 and 76 keeps the nightclothes at the original position even upon the person's returning back from the aimed equipment. Hence, the nightclothes 77 and 76 are put on by the person with reverse operation to that for taking off them.

### EXAMPLE 10

This example shows another example of the nursing nightclothes which is provided, at the hip of the nightclothes 77, with a fastener 80a to be used in excretion as shown in FIG. 17(b). In the example, a rubber belt 80b is provided at the front side of the nightclothes as shown in FIG. 17(a), so that the rubber belt 80b is pulled to be connected with a plane fastener 80c, thereby pulling the front side of the nightclothes, whereby enabling the opening to be made wider when the fastener 80a is opened. Also, the slider 81, thin wire 82 and guide 83 are formed inside the nightclothes 77.

### EXAMPLE 11

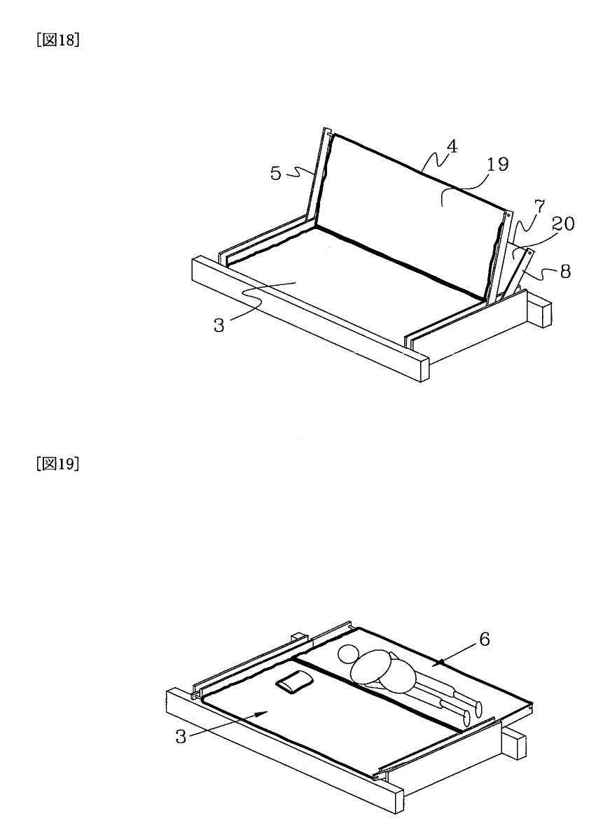

In the foregoing EXAMPLE 2, causing the care-requiring person to be turned over and be transferred from the main bed 3 to the position adjustment bed 6 is performed as shown in FIG. 18. This is the state that, as foregoing, the swing arm 5 at the main bed side provided with the main bed sheet fixing bar 4 interlocks with the swing arm 8 at the position adjustment bed side provided with the position adjustment bed sheet fixing bar 7. And, the swing arms 5, 8 are returned to the original positions, so that the care-requiring person is caused to turn over and be transferred from the main bed 3 to the position adjustment bed 6 as shown in FIG. 19 almost without applying burden to the person. In this case, the care-requiring person is in lying prone on the position adjustment bed 6. A sheet 20 at the position adjustment bed may be formed with a material which breathes well in order to mitigate the state of choking of the person lying prone on the bed 6.

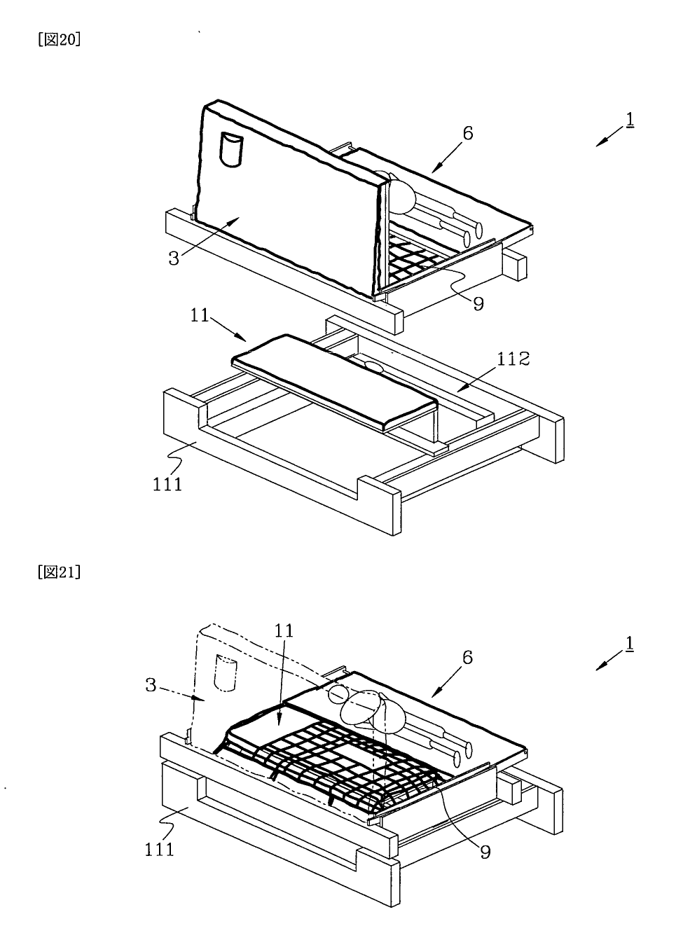

After causing the care-requiring person to be turned over and be transferred to the position adjustment bed 6, the auxiliary bed 11 is slid below the position adjustment bed 6 as shown in FIG. 20 while causing the main bed 3 to make swing movement and move away. And as shown in FIG. 21, the position adjustment bed 6 is moved down to almost the same level of the auxiliary bed 11. In this case, it is preferable that the auxiliary bed 11 is slid toward the bed 6 to have a less gap between them. Also, as foregoing, the auxiliary bed 11 may be moved up to almost the same level as of the position adjustment bed 6. In this example, a set-up type of bathtub 112 which being folded is provided in a frame 111 to which the position adjustment bed 6 is supported in a manner of being capable of sliding and vertically movable. Further, the suspending net 9 is provided with an opening for excretion at a point corresponding to hip.

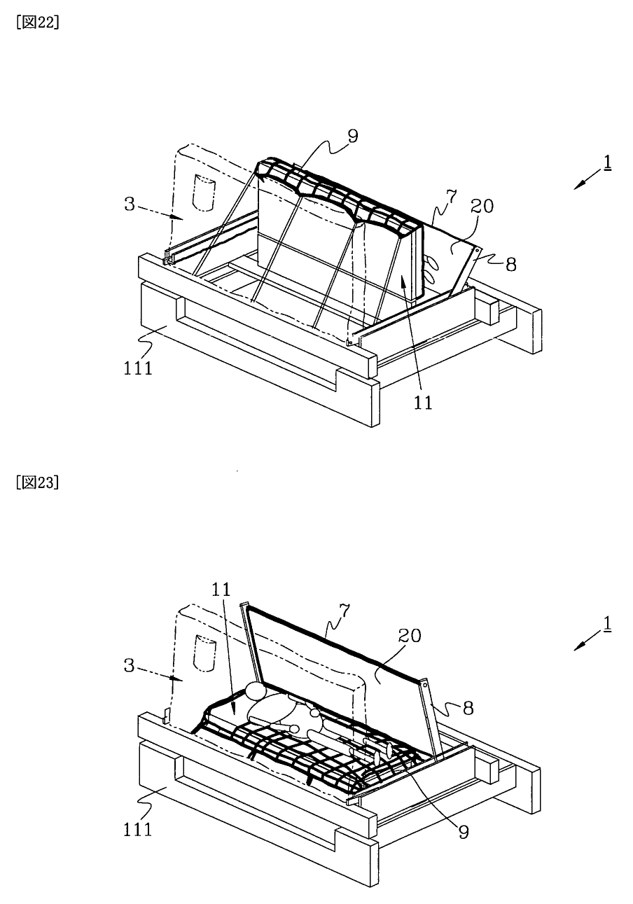

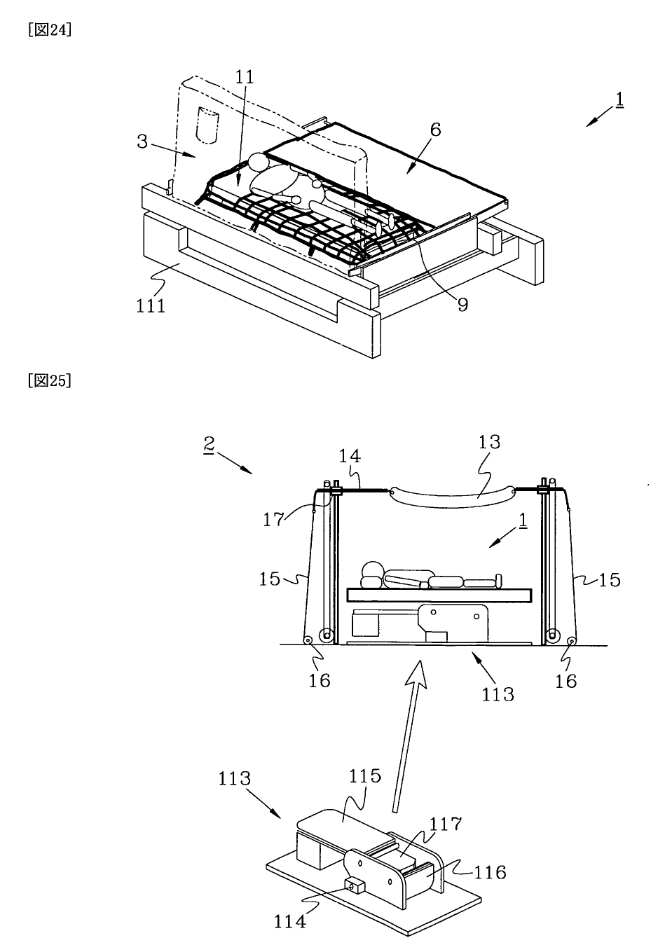

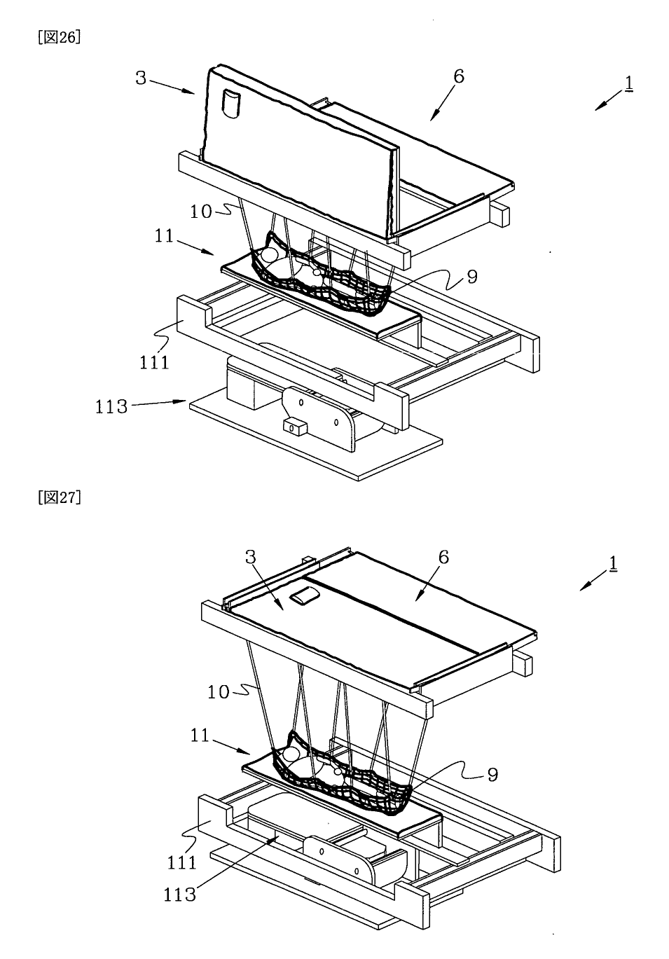

Next, FIGS. 22 through 27 are explanatory views showing the course of operation corresponding to FIGS. 5 to 7 in EXAMPLE 2. In this example, as shown in FIG. 25, there is illustrated an example of provision of a toilet bowl device 113 being capable of sliding and being moved away and put aside almost immediately below the main bed 3.

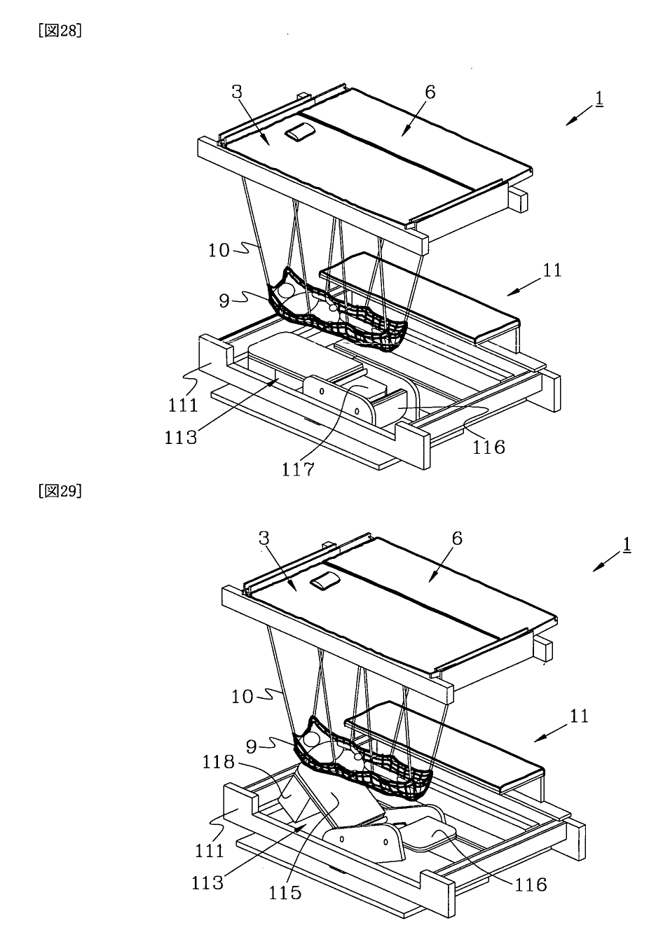

In the state that the care-requiring person lies still on the auxiliary bed 11 with the net 9 interposed between the person and the bed as shown in FIG. 26, the main bed 3 is returned to a predetermined position as shown in FIG. 27, and during the step of moving down the auxiliary bed 11 and at a time before the auxiliary bed 11 gets to the lower end position, the belt 10 is set to be in locked state by the belt controller 24. By this, the care-requiring person suspended by the suspending net 9 is moved away from the auxiliary bed 11 which has reached the lower end position and is brought into a state of completely suspended. In this situation, as shown in FIG. 28, the auxiliary bed 11 is moved laterally, so that the suspended person is transferred to the toilet bowl device 113 positioned immediately below the net.

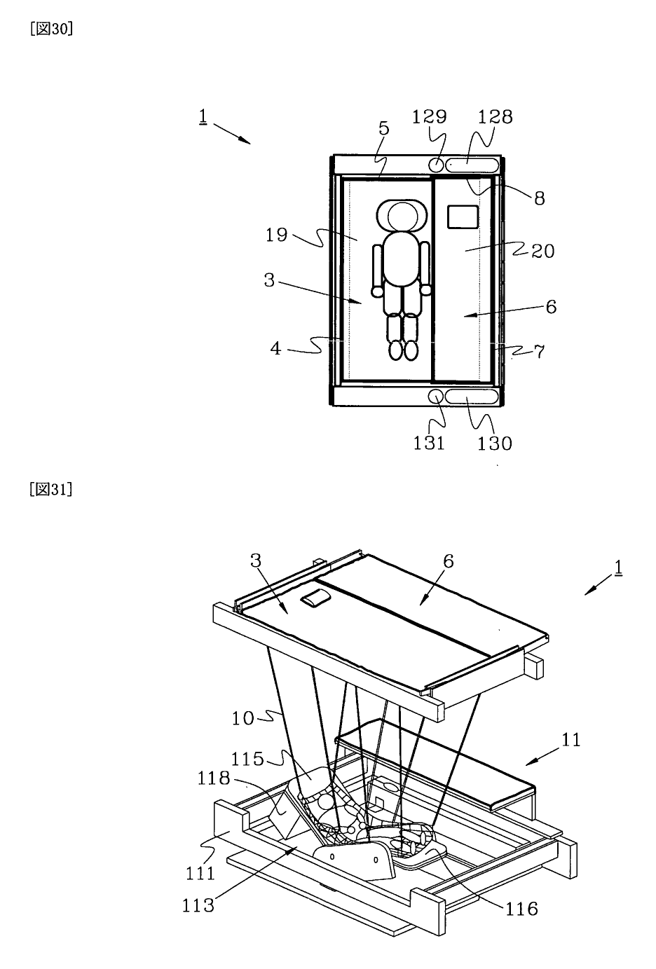

The toilet bowl device 113 of this example is structured in the form of a toilet serving also as a relaxing chair and is installed in the state of being folded. The parts are slanted moved around an axis 114 (FIG. 25) as a fulcrum, so that a backrest 115 and a leg receiver 116 are raised as shown in FIG. 29. A toilet bowl cover 117 serving also as a chair is slid toward a tank 118 to expose a toilet seat. Culture medium material is used for the toilet bowl device 113 to decompose into water vapor and carbonic acid gas, thereby reducing disposing of excrement. To the tank 118 for storing water to be used for toilet, water is fed from a tower shaped tank 128 mounted on the bed at the side of head as shown in FIG. 30. At the tower-shaped tank 128, water supply tank for toilet and bathtub together with a hot water heat retaining tank for taking a bath are mounted in a manner of defining a tower shape. Further, a reservoir tank 129 for electrolytic washing water causing dirt on the body, bathtub 112 and toilet bowl device 113 to be easily removed is arranged by the tower-shaped tank 128. The reservoir tank 129 has a feeding function of automatically mixing the electrolytic washing water with running water when fed to the tower-shaped tank 128. And at the side of feet on the bed, a filthy water tank 130 for a bathtub connected to a general drainage is provided. In case of not using the bio-type toilet bowl device 113, a filthy water tank 131 for excrement is needed to be provided.

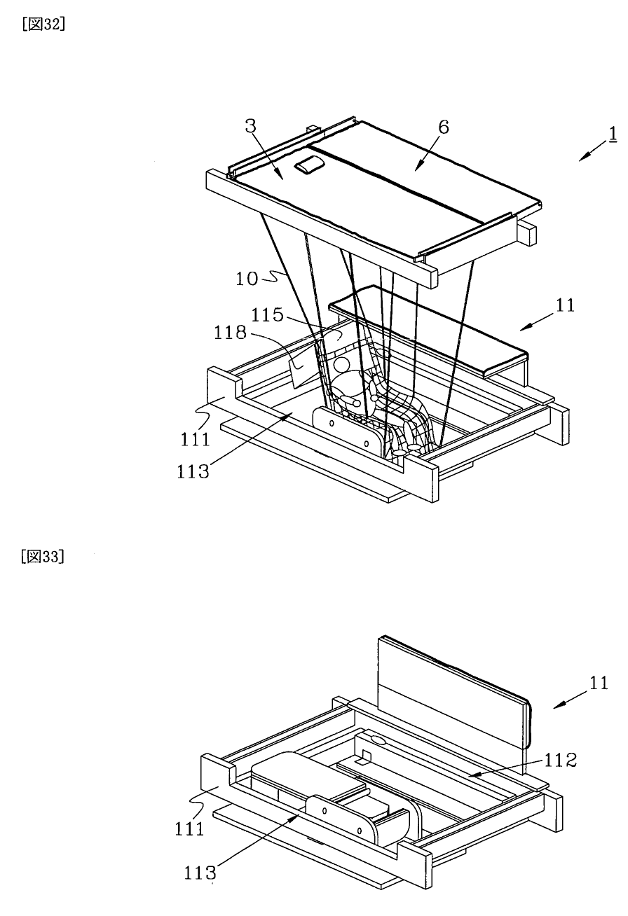

The toilet bowl device 113 is set up and the care-requiring person is placed on the device 113 as shown in FIG. 31. And the back 115 is further raised up as shown in FIG. 32, the device serves as a relaxing chair on which the care-requiring person sits. Excretion is done in this situation. The suspending net 9 has an opening part through which the person does excretion in the posture. The toilet seat is provided with function of washing and drying, thereby allowing the care-requiring person to finish excreting without necessity of a particular act.

### EXAMPLE 12

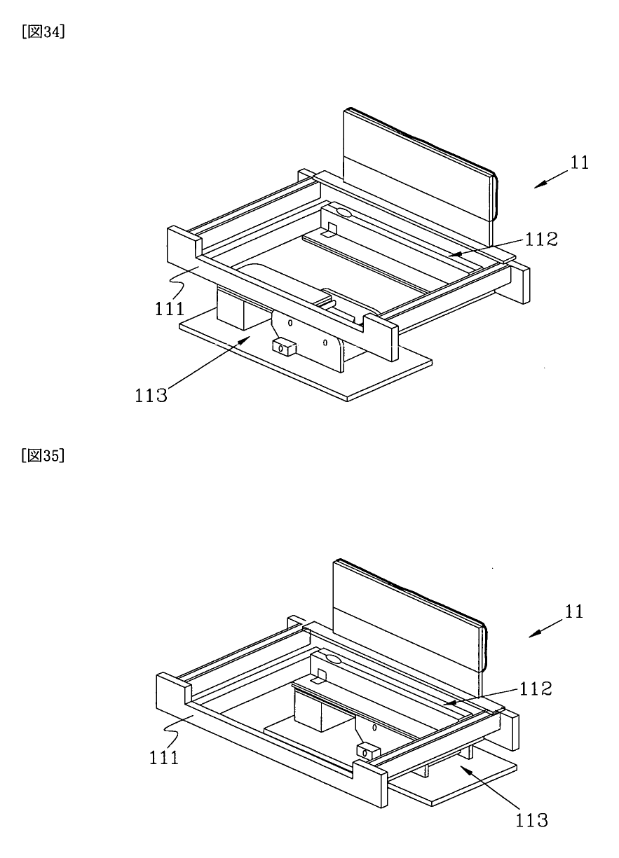

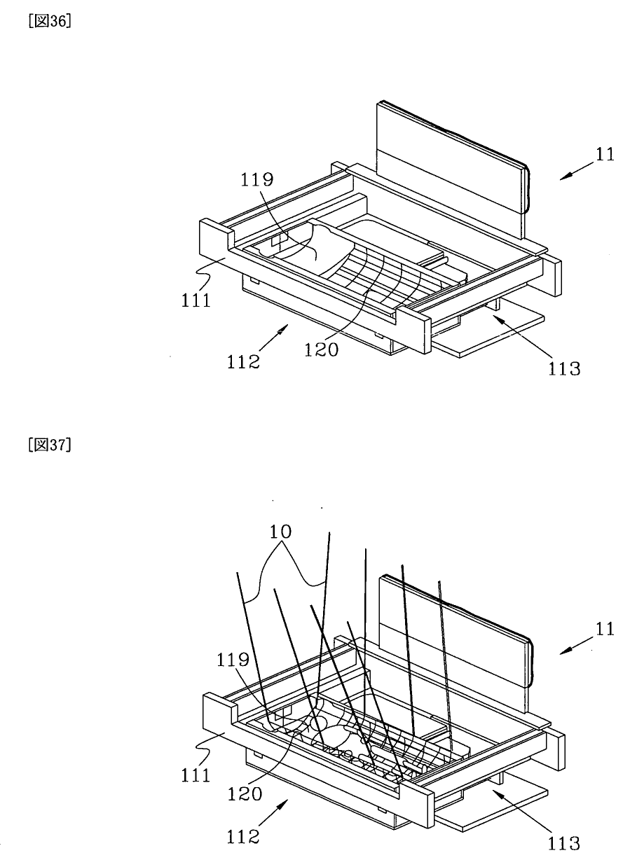

When taking a bath by use of a set-up type bathtub 112, the same operation steps as foregoing leading to the state shown in FIG. 28 (in which the care-requiring person is completely suspended by the suspending net 9) is carried out. Preliminarily to use of the set-up type bathtub 112, the auxiliary bed 11 is first set upright from being horizontal (FIG. 33). Then, as shown in FIG. 34, the frame 111 mounting the auxiliary bed 11 is moved up to the height that the set-up type bathtub 112 does not contact with the toilet bowl device 113, followed by shifting laterally the toilet bowl device 113 as shown in FIG. 35.

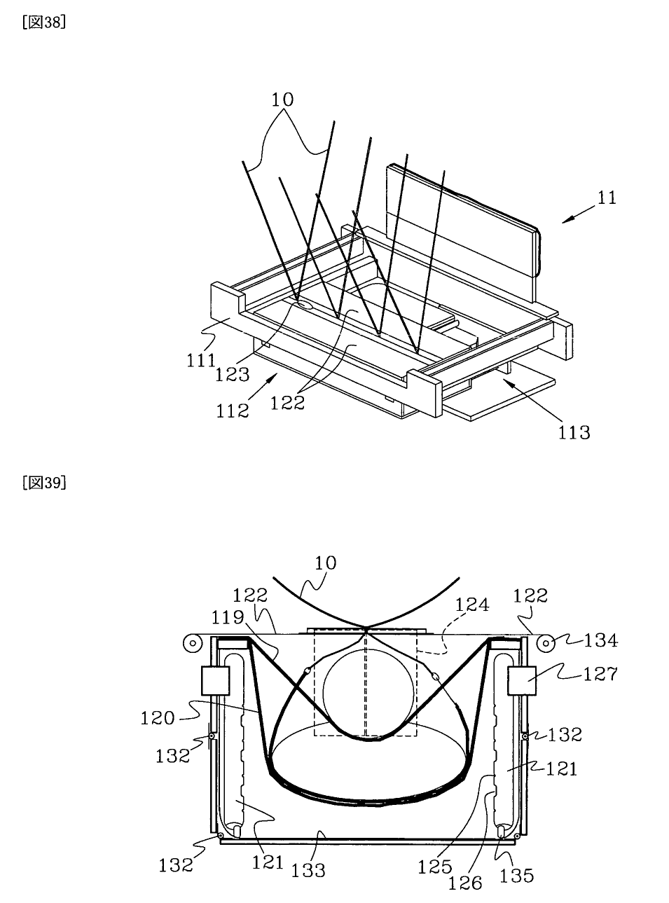

The set-up type bathtub 112 is so structured that the bathtub is automatically set up from interlocking the movement of being moved immediately below the care-requiring person as shown in FIG. 36. The set-up type bathtub 112 is provided in the bathtub with a waterproof sheet 119 for receiving head and rough net 120. This is provided for preventing the body of the care-requiring person from contacting with the bottom and side surfaces inside the bathtub since a sliding type body washing device 121 is mounted on both side surfaces in the bathtub. Into the bathtub 112 set up in the manner the person requiring care is placed down as shown in FIG. 37. In this case, the head-receiving waterproof sheet 119 is set higher in height to some extent, so that the head of the person is prevented from soaking in hot water.

After transferring the person requiring care into the bathtub, the belt controller 24 is operated to set free the suspending belt 10, and a bathtub cover 122 is moved from both sides to the central part to cover the bathtub as shown in FIG. 38. The bathtub cover 122 has a semi-circular opening 123 at the point corresponding to face of the care-requiring person for easy breathing. Upon washing the body, a waterproof sheet 124 is hung down through the semi-circular opening for preventing hot water from splashing over the person's face and head.

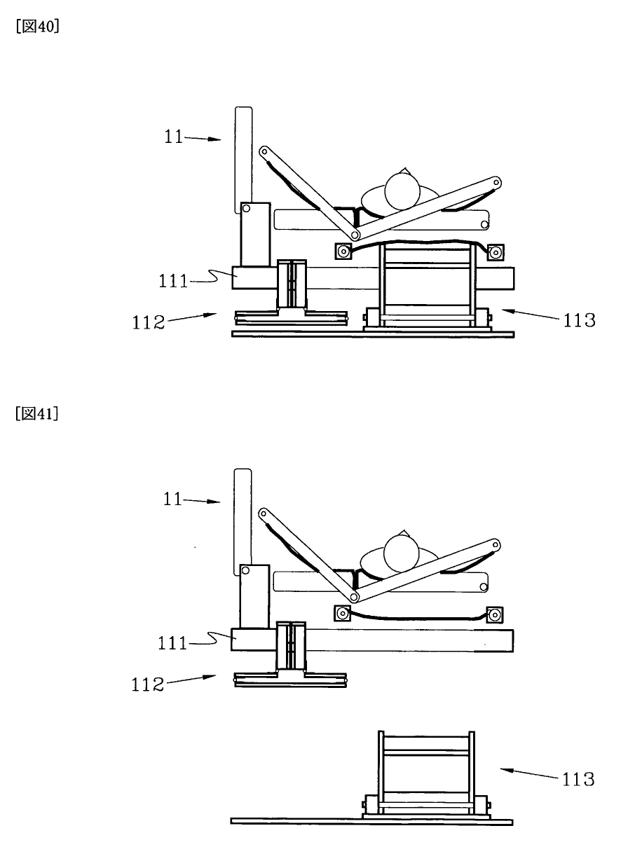

FIG. 39 shows a structure of the set-up type bathtub 112. For movement of washing body of the person requiring care, the head side of the bathtub is first set higher in height to some extent, the body washing device 121 placed at both side faces in the bathtub is actuated. The body washing device 121 is provided with a nozzle 125 for hot water and compressed air, and hot air port 126 for drying. The body washing device 121 makes washing during being moved by a pipe slide mechanism 127. Operation is intensively repeated, particularly, around hip. Hot water in the bathtub in this instance contains excrement and is thereby fed from a discharge port formed at the feet side to a culture medium type disposer bath of the toilet unit. A filthy water from washing the whole body then carried out is collected with a filthy water tank 130 mounted at the feet side. Washing the body is performed with the bathtub being slanted for preventing a filthy water from flowing to and over chest. Slanting the bathtub makes easy drainage. Destination of drainage is switched over depending on contents of the filthy water.

The body of the set-up type bathtub 112 is structured to be folded with a hinge 132 having a spring and is provided inside with a waterproof sheet 133. The bathtub cover 122 is in the form of sheet to be wound by a winding mechanism 134 using a spiral spring. Also, the body washing device 121 has at the lower end a roller 135, so that the device 121 is moved with the roller rotating following moving up of the bottom of the bathtub when folded, thereby causing the body washing device 121 to be accommodated in a state of being slanted to such extent of almost extending horizontally.

Upon completion of washing the body, the slanted bathtub is set horizontal and hot water is fed at high speed with a thick hose from the tower-shaped tank 128 at the head side, thereby making short time to wait for feeding of a predetermined quantity of hot water. In the situation, an interval between letting go of the switch box 25 and operation of the “return” switch 49 is a time interval of taking a bath which may be set freely. Further, a bubble bath effect is enjoyable with compressed air jetted by hot water and compressed air nozzle 125 of the body washing device 121 when slid from feet to neck. Feeding water to the tower-shaped tank 128 and disposal in the filthy water tank 130 are dealt with plain work using an exclusively usable hose provided in the bed.

After transferred onto the net 120 supporting the body of the person requiring care in the bathtub, the bathtub side automatically performs the whole steps of operation. Stoppage of operation is available for all of the movements including taking a bath by operating the “return” switch 49 on the switch box 25. For example, when feeling a need to urinate halfway through taking a bath, a change of aims is possible. In this case, a switch-over switch 47 on the switch box is changed from “taking a bath” to “toilet” and “go” switch 48 is turned on, so that if the body is wet, the body drying movement is first performed, then, transferring to toilet starts in a shortest movement.

Next, a procedure of automatic setting-up of the set-up type bathtub 112 will be detailed.

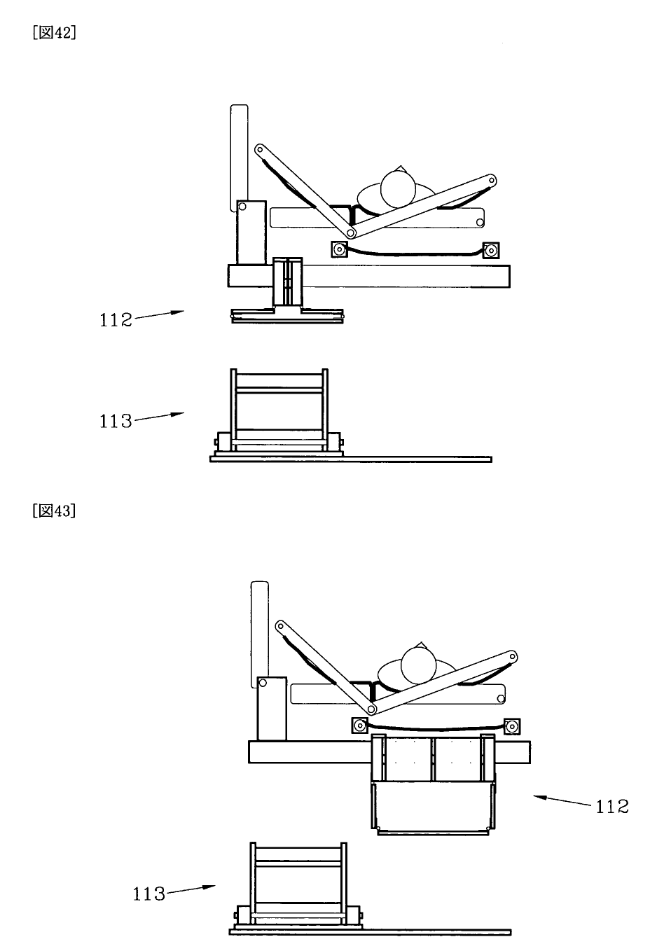

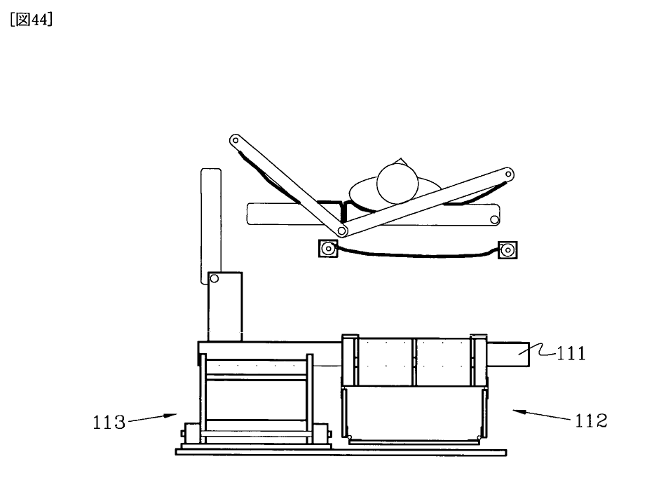

First, as shown in FIG. 40, in a state that the person requiring care is lying on the bed, a switch of aims selection is set to “taking a bath” to cause movement to start. Following this, as a preliminary step for setting up the bathtub, the whole of the main bed and the position adjustment bed are moved up as shown in FIG. 41. And as shown in FIG. 42, the toilet bowl device 113 is slid laterally and the bathtub 112 is pulled out at this side and moved to be set up. The bathtub 112 is moved to a predetermined position at this side as shown in FIG. 43 to reach a fixed position, thereby completing the set-up. Next, a frame 111 is moved down to arrange the bathtub 112 and the toilet bowl device 113 side by side as shown in FIG. 44, thereby completing preparation movement for taking a bath, followed by transferring the body of the care-requiring person to the bathtub 112.

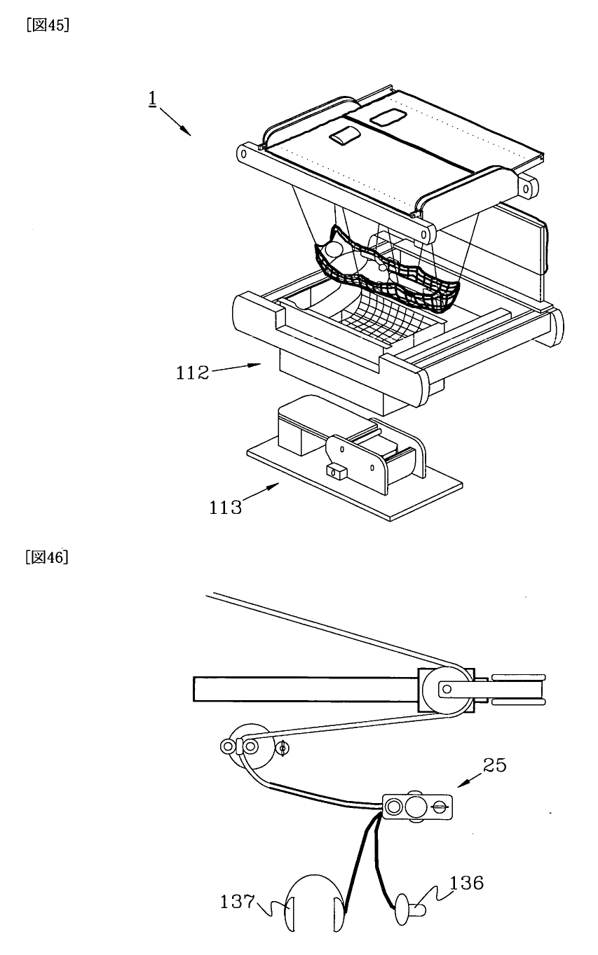

FIG. 45 shows positional correlation between the set-up type bathtub 112 and the toilet bowl device 113. For convenience of understanding, the toilet bowl device 113 is illustrated below the bathtub 112, but, is actually moved away laterally of the bed when the bathtub 112 is set up.

### EXAMPLE 13

FIG. 46 shows another example of the switch box 25 which is waterproof and provided with an earphone 136 and a compact headphone 137. The earphone and the headphone may be given a function as a hearing aid, so that the care-requiring person can use them even in excretion or taking a bath without taking off them.

### EXAMPLE 14

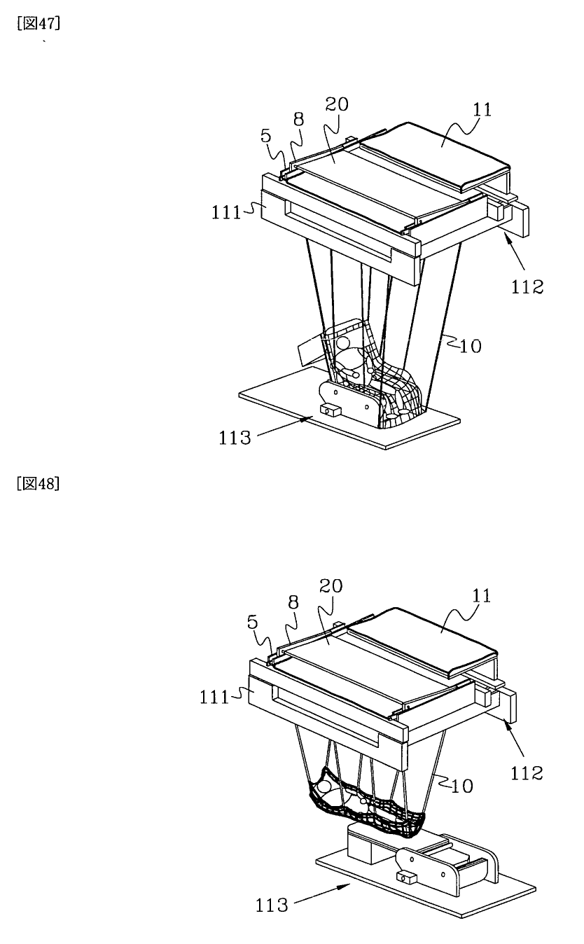

FIG. 47 shows that the auxiliary bed 11 is moved up and away and put aside to obtain a peripheral wide space since the auxiliary bed 11 is trouble in other aims, such as relaxing, talking and having meals, than excretion.

### EXAMPLE 15

FIG. 48 shows that the relaxing chair serving also as a toilet bowl device is put aside, thereby enabling the person requiring care to readily go onto a wheel chair, therapeutic beds, etc. When transferring to a therapeutic bed or the like, it is necessary to previously replace the suspending net 9 with a therapeutic bed sheet by operating one-touch hook. When going out by a wheel chair, the net 9 may be replaced with any other suitable item, thereby solving a problem of appearance.

1-13. (canceled)

14. A bed having a purpose of transferring a person requiring care lying in bed from the bed to a toilet bowl device, the bed having a structure in which there are provided arranged a main bed on which the care-requiring person is to lie and a position adjustment bed arranged adjoining the main bed and supported movably up and down collectively with the main bed, and a suspending equipment which is provided below the main bed to support the care-requiring person in a state of suspending the person and is moved up and down through the moving up and down operation of the main bed and the position adjustment bed movable up and down collectively with each other, and at a further lower position with an auxiliary bed which is caused, in a state of putting the suspending equipment thereon, to adjoin the position adjustment bed with the main bed having made a moving-away swing movement to rotate upwards moving away from the position adjustment bed, and further below the auxiliary bed with the toilet bowl device, wherein the main bed and the position adjustment bed are each provided with a swing arm at the main bed side and the position adjustment bed side, respectively, the swing arms being used to cause the care-requiring person lying on the main bed to turn over and be transferred to the position adjustment bed, the swing arms having a rotation axis near the adjoining parts of the main bed and the position adjustment bed, the main bed and the position adjustment bed each having a sheet with its one end fixed to the adjoining sides of the beds and the other end mounted to a sheet-fixing bar of the swing arm at the main bed side and the position adjustment bed side, and the auxiliary bed is provided with such function that the auxiliary bed swings, together with the swing arm at the position adjustment bed side, upwards toward the position adjustment bed for turning-over and transferring the care-requiring person, who has been already transferred to the position adjustment bed, to the auxiliary bed on which the suspending equipment is put, and also such function that the auxiliary bed slides and moves away, with the main bed and the position adjustment bed being lifted up, for enabling the care-requiring person in a state of being suspended by the suspending equipment to be transferred to the toilet bowl device.
